(19) United States
(12) Patent Application Publication
(10) Pub. No.: US 2002/0037013 A1
(43) Pub. Date: Mar. 28, 2002

(54) Method of optically transmitting SDH or SONET signals

(75) Inventor: Gert Grammel, Uhingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/951,706

(22) Filed: Sep. 14, 2001

(30) Foreign Application Priority Data
Sep. 26, 2000 (DE) 100 47 511.6

(51) Int. Cl. H04Q 11/02

(52) U.S. Cl. 370/430; 370/535; 370/252

(57) ABSTRACT

In the case of the transmission of SDH signals by WDM, a plurality of SDH signals is distributed over a plurality of wavelengths in such a way that one wavelength is used in each case for each SDH signal. Instead of modulating an SDH signal, for example STM-1, STM-4, STM-16 or STM-64, directly onto a wavelength, a plurality of SDH signals are, according to the invention, merged, provided with additional information and distributed over the available wavelengths. A cross-connect (O-CC) and a control unit (DSP) and also an optical converter (U) are provided in an appliance for the optical transmission of SDH signals, in order to perform the distribution.

### TECHNICAL FIELD

The invention relates to a method of optically transmitting SDH or SONET signals. The invention is based on a priority application DE 100 47 511.6 which is hereby incorporated by reference.

### BACKGROUND OF THE INVENTION

In the case of line-conducted signal transmission, ever-higher bandwidths are required in order to be able to keep pace with the expected explosion in bandwidth requirement, in particular as a result of Internet services. A very promising technology in this connection is DWDM, which makes it possible to transmit optical signals at various wavelengths via a single glass fibre (DWDM=dense wavelength-division multiplexing). DWDM is used, for example, for the line-conducted optical transmission of SDH signals. An SDH signal is, for example, an STM-1 or an STM-4 signal. The SDH signal is electrical. It is converted electrically/optically to a certain wavelength. A plurality of STH signals are distributed over a plurality of wavelengths in such a manner that one wavelength is used in each case for each SDH signal. On the wavelength, for example, a single baseband transmission takes place. All the wavelengths are then transmitted jointly over an optical line by wavelength-division multiplexing. One wavelength is also used in each case for SDH signals having a low bit rate. The free capacity of a wavelength seized by an SDH signal having a low bit rate cannot additionally be used. The total capacity of the available wavelengths is consequently not utilized in an optimum manner. In addition, if a certain wavelength is faulty, the SDH signal transmitted via it is likewise faulty and cannot, consequently, be transmitted fault-free. The fault or an increased attenuation of a wavelength is due, or example, to the use of different fibres and/or amplifiers. The fault or increased attenuation may result in increased bit-error rates, which may limit the use of the associated wavelength for transmission purposes. In addition, in the event of outage of a laser that generates a certain wavelength, the connection is completely out-of-order. Furthermore, the available wavelength range has to be measured out individually per connection. The impairment of the transmission behaviour of one or more wavelengths in the optical WDM equipment can furthermore not be measured directly since error rates can be evaluated only in the downstream electrical SDH equipment.

### SUMMARY OF THE INVENTION

The object of the invention is to provide a method or an appliance or a system for optically transmitting SDH or SONET signals that is optimized with respect to the prior art.

This object is achieved by a method of line-conducted optical transmission of SDH or SONET signals, including by the following steps:

distribution of the SDH or SONET signals to be transmitted over a number of available wavelengths and inclusion of items of additional information comprising items of information relating to the distribution, wherein a first wavelength serves to transmit at least a part of a first SDH or SONET signal and at least a part of a second SDH or SONET signal and

transmission of the wavelengths over at least one optical line by multiplexing

and an appliance characterized in that, instead of the SDH or SONET signals, other synchronous or asynchronous signals are transmitted optically and in that, in the case of asynchronous signals, synchronization is performed prior to the distribution and a system for the line-conducted optical transmission of SDH or SONET signals characterized in that the system comprises an appliance according to claim 4, a receiving device and at least one optical line for connecting the appliance to the receiving device, in that the receiving device has a cross-connect and a control unit, wherein the control unit is capable of selecting and evaluating the information relating to the distribution and of performing a distribution of the received signals in such a way that the output signals of the cross-connect correspond to the input signals of the cross-connect of the appliance.

Instead of modulating an SDH signal, for example STM-1, STM-4, STM-16 or STM-64, directly onto a wavelength, a plurality of SDH signals are merged, provided with additional information and distributed over the available wavelengths. The distribution takes place in such a way that the available optical capacity is utilized in an optimized manner. The additional information is inserted, for example, in the form of a so-called overhead, i.e. a head section. The overhead can then be used at the receiving end of a WDM or DWDM system to measure the transmission quality of every individual wavelength. If the transmission behaviour becomes poorer, higher modulation levels can be chosen for an individual wavelength or for a plurality of wavelengths. As a result of the higher modulation level, the transmittable data rates become correspondingly lower. A central control mechanism ensures that all the wavelengths are loaded with data in accordance with their data rate. The outage of a wavelength produces only a higher bit-error rate and not the outage of the complete signal. Provided the transmission capacity of the remaining wavelengths is adequate, the WDM or DWDM system can restore the required transmission quality independently.

The additional information may comprise items of information relating to an error correction, for example a forward error correction (FEC). The error rate can be minimized by using FEC mechanisms.

The use of the control mechanism and of the FEC mechanism can achieve the result that inexpensive lasers can be used.

The (D)WDM system according to the invention adapts independently to the transmission conditions. It can be installed in a simple manner. The outage of a wavelength does not result in an interruption of a connection. Impairments of the transmission quality are detected during operation and can be compensated for automatically.

The bandwidth per application is limited only by the number of wavelengths and the transmission behaviour of the link. The available transmission bandwidth is used better since, for example, a high-quality wavelength is not exclusively seized by a low-bit-rate connection.

The advantages are not only in the fault immunity, but, above all, in the automatic adaptation to the available optical windows and the possibility of being able to react to outages. Because of the on-line monitoring, the (D)WDM system can react promptly. It is self-healing in that it independently and automatically performs a redistribution of data over the wavelengths.

### BRIEF DESCRIPTION OF THE DRAWINGS

An exemplary embodiment of the invention is explained below using three figures. In the figures:

FIG. 1 shows a schematic representation of an appliance according to the invention for the line-conducted optical transmission of SDH signals by means of DWDM,

FIG. 2 shows a diagram of the SDH signals to be transmitted and

FIG. 3 shows a diagram of a signal distribution over an optical transmission line.

### BEST MODE FOR CARRYING OUT THE INVENTION

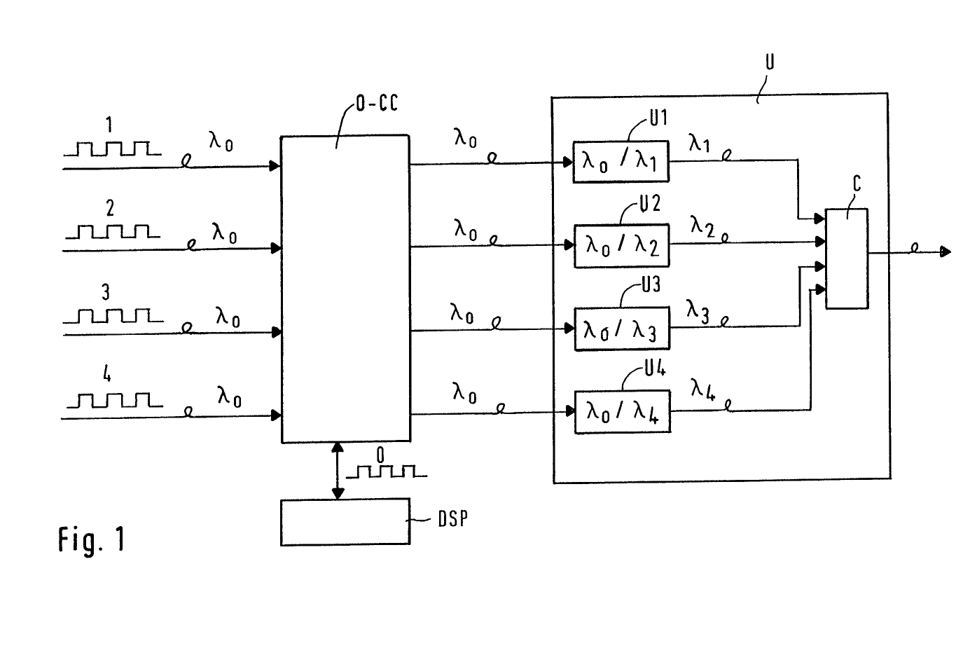

The appliance according to the invention in FIG. 1 has a cross-connect O-CC having four inputs and four outputs and also one control input/output. The control input/output is connected to a control unit DSP that is designed as a digital signal processor. The outputs are connected to an optical converter U that has four inputs and one output.

The cross-connect O-CC is designed as an optical cross-connect having an electrical control input. Every input of the cross-connect O-CC can be connected to every output of the cross-connect O-CC. Every data packet, in the minimum case every bit, applied to an input can consequently be forwarded to any output.

Applied to the first input of the cross-connect O-CC is a first SDH signal denoted by the numeral 1. The SDH signal has already been electrically/optically converted and is modulated onto the wavelength λ₀. The SDH signal is, for example, a STM-1 signal that requires a data rate of 155 Mbit/s.

Applied to the second input of the cross-connect O-CC is a second SDH signal denoted by the numeral 2. The SDH signal has already been electrically/optically converted and is modulated onto the wavelength λ₀. The SDH signal is, for example, an STM-1 signal that requires a data rate of 155 Mbit/s.

Applied to the third input of the cross-connect O-CC is a third SDH signal denoted by the numeral 3. The SDH signal has already been electrically/optically converted and is modulated onto the wavelength λ₀. The SDH signal is, for example, an STM-1 signal that requires a data rate of 155 Mbit/s.

Applied to the fourth input of the cross-connect O-CC is a fourth SDH signal denoted by the numeral 4. The SDH signal has already been electrically/optically converted and is modulated onto the wavelength λ₀. The SDH signal is, for example, an STM-1 signal that requires a data rate of 155 Mbit/s.

The control unit DSB serves, in particular, to control the distribution of the SDH signals over the outputs of the cross-connect O-CC. The control unit DSP supplies items of additional information that are likewise forwarded to the outputs of the cross-connect O-CC. The items of additional information contain, in particular, items of information relating to the distribution of the SDH signals over the wavelengths. At the receiving end, a reconversion can then take place using said items of information to recover the individual SDH signals. In addition to the items of information relating to distribution, the items of additional information may contain items of information for error correction, for example so-called forward error correction. Said items of information are generated in the control unit DSP and transmitted with the SDH signals. At the receiving end, a bit-error measurement, for example, can then be performed by means of said items of information. The result of the bit-error measurement is transmitted, for example, to the control unit DSP. In the control unit, a suitable redistribution of the signals then takes place depending on the result of the bit-error measurement. The items of additional information are generated electrically in the control unit DSP and converted by means of an electrical/optical converter into optical signals that are fed to the cross-connect O-CC. The feed takes place, for example, via a fifth input of the cross-connect O-CC. Alternatively, the items of additional information are generated electrically in the control unit, multiplexed by means of an electrical multiplexer with the electrical SDH signals to be transmitted, converted electrically/optically together with the latter and fed to the cross-connect O-CC via one of the four inputs. Compared with the SDH signals, the items of additional information have a low data rate.

The optical converter U serves to convert the output signals of the cross-connect O-CC into a wavelength-division multiplex signal that is transmitted via optical lines to a receiving device. The output signals of the cross-connect O-CC are all transmitted at the some wavelength λ₀. The optical converter comprises four wavelength converters U1, U2, U3, U4. The wavelength converter U1 serves to convert the output signals of the first output of the cross-connect O-CC of wavelength λ₀ to wavelength λ₁. The wavelength converter U2 serves to convert the output signals of the second output of the cross-connect O-CC of wavelength λ₀ to wavelength λ₂. The wavelength converter U3 serves to convert the output signals of the third output of the cross-connect O-CC of wavelength λ₀ to wavelength λ₃. The wavelength converter U4 serves to convert the output signals of the fourth output of the cross-connect O-CC of wavelength λ₀ to wavelength λ₄. The four wavelengths λ₁ to λ₄ are then superimposed in an optical combiner C so that a DWDM signal is produced at the output of the optical converter.

The four SDH signals at the inputs of the cross-connect O-CC are then partitioned by the cross-connect O-CC and the control unit DSP in such a way that the available wavelength capacity is optimally utilized.

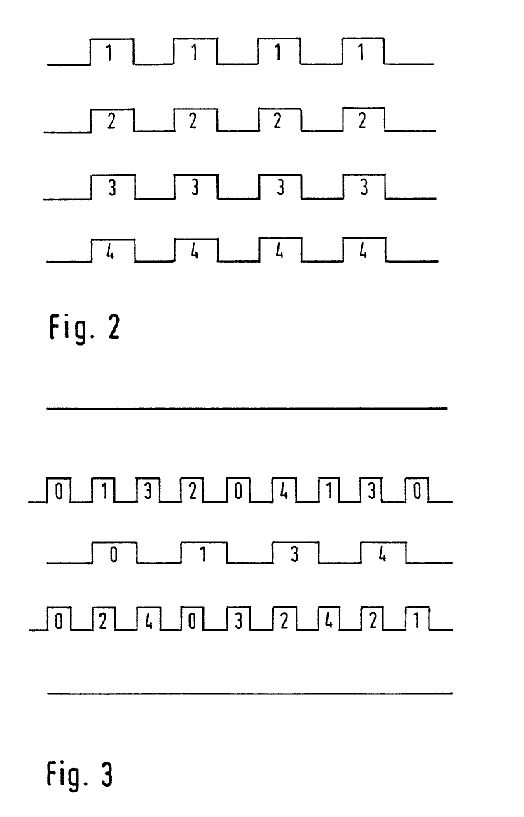

FIG. 2 shows, by way of example, the four SDH signals to be transmitted. The SDH signal at the first input of the cross-connect O-CC is provided with the numeral 1. The SDH signal at the second input of the cross-connect O-CC is provided with the numeral 2. The SDH signal at the third input of the cross-connect O-CC is provided with the numeral 3. The SDH signal at the fourth input of the cross-connect O-CC is provided with the numeral 4.

FIG. 3 shows by way of example the distributed SDH signals at the outputs of the cross-connect O-CC together with the items of additional information. The four SDH signals are provided, as in FIG. 2, with the numerals 1-4. The items of additional information are provided with the numeral 0. The transmission capacity of a wavelength is, for example, in the range from 2.5 to 10 Gbit/s. The wavelength λ₁ is undisturbed, for example, on the transmission link to the receiving device. It can therefore be used for high-bit-rate transmission. The wavelength λ₁ is used, for example, to transmit those items of additional information that comprise the items of information relating to the distribution. Said items of additional information are transmitted, for example, every four bits or every four bytes or at specified time intervals known to the receiving device. This simplifies the evaluation at the receiving end. FIG. 3 therefore shows in the first output signal of the cross-connect O-CC a data packet characterized by the numeral 0 every four time units. The data packets of the SDH signals are distributed according to a control mechanism that is programmed into the control unit DSP, for example by means of software. The first output signal of the cross-connect O-CC contains data packets of all four SDH signals 1-4. The data rate available at the wavelength λ₁ is higher than the data rate of the four SDH signals so that at least parts of the latter can be transmitted in multiplexed form by means of this one wavelength. The wavelength λ₂ is, for example, faulty on the transmission link to the receiving device. It can therefore be used, for example, only to transmit a bit rate that is half as great as the bit rate of the wavelength λ₁. The second output signal of the cross-connect O-CC contains data packets of the SDH signals 1, 3 and 4 and also items of additional information that comprise items of information relating to error correction. The wavelength λ₃ is, for example, undisturbed on the transmission link to the receiving device. It can therefore be used for high-bit-rate transmission. The third output signal of the cross-connect O-CC contains data packets of all the SDH signals 1-4 and also items of additional information that comprise items of information relating to error correction and/or items of maintenance information and/or items of monitoring information. The wavelength λ₄ is, for example, faulty over the transmission link to the receiving device in such a way that it cannot be used for data transmission. The fourth output signal of the cross-connect O-CC therefore contains neither data packets nor items of additional information. The four SDH signals can consequently be transmitted by means of three wavelengths. If the circumstances change, for example outage of wavelength λ₁ and undisturbed wavelengths λ₂ to λ₄, the control unit DSP will independently undertake a redistribution. Since the wavelength λ₁ can now no longer be used to transmit items of additional information, the second wavelength λ₂ is used to transmit the items of additional information, at least the item of additional information comprising the distribution information. The four SDH signals are accordingly distributed over the three wavelengths λ₂ to λ₄. The distribution preferably takes place in such a way that approximately the same amount of data is transmitted on every wavelength. In the exemplary embodiment, four STM-1 SDH signals are to be transmitted. Each STM-1 signal has a data rate of 155 Mbit/s. Four STM-1 signals therefore have a data rate of 620 Mbit/s. In this case, all four SDH signals can also be transmitted using one wavelength. The four signals are then transmitted, for example in multiplexed form, by means of the wavelength λ₁. The remaining three wavelengths can then be used for transmitting further SDH signals.

At the receiving end, the receiving device has an inverse structure to the appliance according to FIG. 1. The receiving device comprises, for example, an optical converter that comprises a wavelength-selective optical splitter and four wavelength converters. The splitter receives the DWDM signal via the optical line and partitions it into the four wavelengths. Each wavelength is converted to the wavelength λ₀ in a wavelength converter. The optical converter has four outputs that are connected to the inputs of a cross-connect. The cross-connect has four outputs for providing the four SDH signals transmitted and an interface to a control unit that is designed, for example, as a digital signal processor.

From the items of additional information, which are transmitted at specified time intervals known to the control unit, the control unit determines the distribution key and controls the cross-connect in such a way that the correct data packets are switched to the correct outputs of the cross-connect. A temporary memory may be necessary. The control unit is furthermore capable of performing a bit-error measurement for each wavelength. If the control unit ascertains that the transmission on a wavelength is faulty, it informs the control unit of the appliance in FIG. 1 at the transmitting end. The communication takes place, for example, via an electrical or optical connection to the appliance. The optical line between appliance and receiving device may also be designed bidirectionally so that optical signals can be transmitted from the appliance to the receiving device and from the receiving device to the appliance over one and the same line. The receiving device additionally comprises a transmitting device for injecting the optical signals to be transmitted into the optical line. In the case of bidirectional operation, two cross-connects, a control unit and two optical converters may be installed, for example, both at the transmitting end and at the receiving end. One cross-connect then serves to transmit SDH signals and the other cross-connect to receive SDH signals. The control unit controls both cross-connects. The items of information relating to the bit-error measurement can then be transmitted in the outward direction together with the items of additional information in the return direction.

In the exemplary embodiment, the cross-connect has four inputs and four outputs. These numbers have been chosen by way of example. The cross-connect may also have more inputs or outputs or fewer; the number of inputs and outputs may also be different. The minimum number of inputs for a cross-connect is two. The minimum number of outputs for a cross-connect is two.

Instead of an electrically controlled optical cross-connect, a purely optical cross-connect may also be used. The control is then also undertaken via an optical interface. The control unit itself is then purely optical and has at least one optical interface. Alternatively, the cross-connect may also be designed as an electrical cross-connect. The SDH signals are then fed electrically to the cross-connect and distributed electrically in the cross-connect. The outputs of the cross-connect are connected to an electrical/optical converter that converts each output electrically/optically. All the optical output signals then have, for example, the same wavelength. The optical converter for converting and combining the wavelengths is then downstream of the electrical/optical converter.

Instead of a digital signal processor, a microprocessor or a suitably programmed component may also be used as control unit. The component is, for example, a so-called FPGA.

The invention may also be applied analogously to a WDM system instead of to a DWDM system. Instead of SDH signals, SONET signals may analogously be transmitted. Instead of STM-1 signals, STM-4, STM-16 and STM-64 signals or the like may analogously be transmitted. It is also possible to transmit SDH signals of different bit rates, that is to say, for example, STM-1 and STM-4 signals or STM-1, STM-4 and STM-16 signals or STM-16 and STM-64 signals using one and the same cross-connect.

In the simplest application case, the cross-connect mutliplexes two SDH signals and transmits them jointly via one wavelength.

Instead of one optical line, a plurality may also be used. The plurality of optical lines may then be partitioned, for example, over at least two different transmission links to generate at least two independent paths. If a cable break occurs on one link, for example, as a result of dredging, the signals to be transmitted can be redistributed in such a way that they are transmitted over another link that is not impaired. The optical SDH signals can also be transmitted to a plurality of receiving devices instead of to one receiving device. For this purpose, for example, a distribution network is used that comprises optical lines and optical splitters. Instead of a distribution network, a mesh-type network or a ring network may also be used.

The invention can also be applied to digital signals other than SDH or SONET signals, for example GigabitEthernet or ATM signals. SDH and SONET signals are transmitted synchronously. Multiplexing is therefore easily possible. GigabitEthernet and ATM signals are transmitted asynchronously. They are not synchronous with one another or with the SDH/SONET signals. In this case, an additional modification is necessary. The adaptation function necessary for the modification provides synchronization, for example, for the optical transmission.

1. Method of line-conducted optical transmission of SDH or SONET signals, including by the following steps:
distribution of the SDH or SONET signals to be transmitted over a number of available wavelengths and inclusion of items of additional information comprising items of information relating to the distribution, wherein a first wavelength serves to transmit at least a part of a first SDH or SONET signal and at least a part of a second SDH or SONET signal and
transmission of the wavelengths over at least one optical line by multiplexing.

2. Method according to claim 1, including the step: after the items of information relating to the transmission quality of the optical line have been received, a redistribution is performed as a function of the items of information.

3. Method according to claim 1, wherein the items of additional information comprise items of information for error correction.

4. Method according to claim 1, wherein instead of the SDH or SONET signals, other synchronous or asynchronous signals are transmitted optically and wherein, in the case of asynchronous signals, synchronization is performed prior to the distribution.

5. Appliance for the line-conducted optical transmission of SDH or SONET signals, comprising a cross-connect (O-CC) having at least two inputs and at least two outputs for partitioning and distributing the SDH or SONET signals to be transmitted, and a control unit (DSP) that controls the distribution and includes items of additional information that comprise items of information relating to the distribution.

6. Appliance according to claim 4, wherein the cross-connect (O-CC) is designed as an electrically controlled optical cross-connect, as a purely optical cross-connect or as an electrical cross-connect.

7. Appliance according to claim 4, wherein downstream of the cross-connect (O-CC) is an optical converter (U) that serves the conversion to at least two different wavelengths and the combination of said wavelengths.

8. System for the line-conducted optical transmission of SDH or SONET signals comprising an appliance according to claim 4, a receiving device and at least one optical line for connecting the appliance to the receiving device, wherein the receiving device has a cross-connect and a control unit, wherein the control unit is capable of selecting and evaluating the information relating to the distribution and of performing a distribution of the received signals in such a way that the output signals of the cross-connect correspond to the input signals of the cross-connect of the appliance.

9. System according to claim 7, comprising an optical converter is provided that is upstream of the cross-connect and serves to split and to convert the split received signals to one and the same wavelength.

10. System according to claim 7, wherein the receiving device performs a bit-error measurement and the result of said bit-error measurement is transmitted to the appliance, which performs a redistribution of the SDH or SONET signals depending on the result.
